(19) United States
(12) Patent Application Publication
(10) Pub. No.: US 2010/0095250 A1
(43) Pub. Date: Apr. 15, 2010

(54) Facilitating Interaction With An Application

(75) Inventors: Reta Roberto, Plano, TX (US); Larry J. Johnson, Sachse, TX (US); Bruce A. Bumgarner, Plano, TX (US); Hector L. Irizarry, Dallas, TX (US)

Correspondence Address: BAKER BOTTS LLP, 2001 ROSS AVENUE, 6TH FLOOR, DALLAS, TX, 75201-2980, US

(73) Assignee: Raytheon Company, Waltham, MA (US)

(21) Appl. No.: 12/251,643

(22) Filed: Oct. 15, 2008

(51) Int. Cl. G06F 3/033

(52) U.S. Cl. 715/863

(57) ABSTRACT

An apparatus for facilitating interaction with an application includes a memory and logic. The memory stores image data generated by an instance of an application. The logic repeats the following for each user of a number of users: receives a sensor signal representing a gesture performed by a user and indicating a user instruction; modifies the image data according to the user instruction; and sends the image data to initiate a display of an image according to the user instruction.

### TECHNICAL FIELD

This invention relates generally to the field of server systems and more specifically to facilitating interaction with an application.

### BACKGROUND

An instance of an application may be accessed by different users. Users make requests to the application and receive information from the application. Coordinating access to an instance of the application, however, may be complicated.

### SUMMARY OF THE DISCLOSURE

In accordance with the present invention, disadvantages and problems associated with previous techniques for facilitating access to an application may be reduced or eliminated.

According to one embodiment of the present invention, an apparatus for facilitating interaction with an application includes a memory and logic. The memory stores image data generated by an instance of an application. The logic repeats the following for each user of a number of users: receives a sensor signal representing a gesture performed by a user and indicating a user instruction; modifies the image data according to the user instruction; and sends the image data to initiate a display of an image according to the user instruction.

Certain embodiments of the invention may provide one or more technical advantages. A technical advantage of one embodiment may be that different users may effectively access the same instance of an application. Another technical advantage of one embodiment may be that a user gesture may be used to provide an instruction for the application.

Certain embodiments of the invention may include none, some, or all of the above technical advantages. One or more other technical advantages may be readily apparent to one skilled in the art from the figures, descriptions, and claims included herein.

### BRIEF DESCRIPTION OF THE DRAWINGS

For a more complete understanding of the present invention and its features and advantages, reference is now made to the following description, taken in conjunction with the accompanying drawings, in which:

FIG. 1 illustrates one example of a system configured to facilitate interaction with an application;

FIG. 2 illustrates an example of the system of FIG. 1 that has a collaboration net of servers;

FIG. 3 illustrates an example of the system of FIG. 1 that includes stations; and

FIGS. 4A and 4B illustrate an example of a method for facilitating interaction with an application that may be performed by the system of FIG. 1.

### DETAILED DESCRIPTION OF THE DRAWINGS

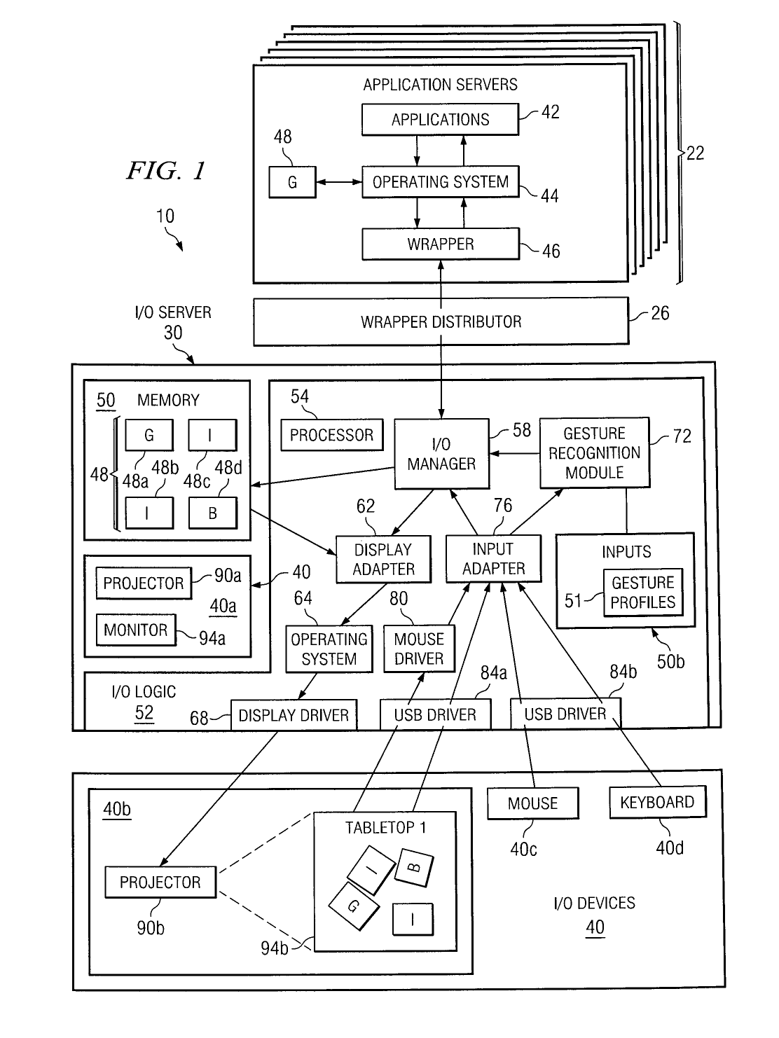

Embodiments of the present invention and its advantages are best understood by referring to FIGS. 1 through 4B of the drawings, like numerals being used for like and corresponding parts of the various drawings.

FIG. 1 illustrates one example of a system 10 configured to facilitate interaction with an application. In the example, different users may access the same instance of an application. Also, a user gesture may be used to provide instruction for the application.

According to one embodiment, “user” may refer to any suitable entity that can provide input to system 10, such as a human being. In one embodiment, a user may provide input to system 10 through a gesture. “Gesture” may refer to movement performed by the user that is sensed by system 10. A particular gesture may indicate an particular instruction, such as an image instruction or an application request. For example, the user may drag an finger across a surface of system 10 to move an image, or may touch an image button of the surface make a request to an application.

In one embodiment, certain users may have priority over other users. For example, system 10 may act on input from a higher priority user over input from a lower priority user. The input from the higher priority user may be acted on prior to or instead of the input from the lower priority user.

In the illustrated embodiment, system 10 includes one or more application servers 22, a wrapper distributor 26, an input/output (I/O) server 30, and one or more I/O devices. An application server 22 includes one or more applications 42, an operating system (OS) 44, one or more wrappers 46, and image data 18.

An application server 22 delivers applications 42 to client devices. An application 42 may be a single user or multiple user application. Examples of single user applications 42 include browsers or MICROSOFT WINDOWS desktop applications. Examples of multi-user applications 42 include a NEW GENERATION application (from NEW GENERATION SOFTWARE, INC.), a MERLE application, and a MICROSOFT SURFACE application (from MICROSOFT CORPORATION). An application 42 may be an existing, or legacy, application. Application image data 48 represents image data generated by a particular application 42. Operating system 44 may represent a desktop operating system.

Wrapper distributor 26 distributes wrappers 46 to requesting I/O devices 40. A wrapper 46 wraps an instance of an application 42. Wrapper distributor 26 may provide wrappers 46 for new instances or for currently running instances. For example, wrapper distributor 26 sends a request for a new instance to wrapper 46. Wrapper 46 starts application 42 and sends connection information to wrapper distributor 26. The connection information describes how to use wrapper 46 to connect to application 42. Wrapper distributor 26 forwards the connection information to I/O devices 40.

Wrapper 46 may process an application request to an application 42. Examples of application requests include update application view, send application input, shut down application, and/or any other suitable request. Wrapper 46 may also communicate the status of the instance to wrapper distributor 26. The status may be communicated in response to a request from wrapper distributor 26 or may be provided automatically, for example, when the application 42 is shut down.

I/O server 30 manages input to and output from application servers 22 and/or I/O devices 40. I/O server 30 includes memory 50 (50a and/or 50b) and logic 52. Memory 50 stores image data 48 (48a, 48b, . . . , and/or 48d) generated by applications 42. Image data 48a-48d represents data 48 generated by different applications 42. Memory 50b stores gesture profiles 51. A gesture profile 51 maps a user gesture to a particular instruction. A particular gesture profile 51 may record the gestures for one or more users. In one embodiment, a gesture profile 51 records gestures for a particular user.

Logic 52 performs any suitable operation of I/O server 30. In one embodiment, logic 52 receives a sensor signal representing a gesture indicating a user instruction. Logic 52 determines whether the instruction is an image instruction to modify image data 48 or an application request for an application 42. If the instruction is an image instruction, logic 52 modifies image data 48 and sends image data 48 to initiate a display of an image. If the instruction is an application request, logic 52 sends the application request to application 42.

In one embodiment, logic 52 receives a first sensor signal indicating a first image instruction from a first user and a second sensor signal indicating a second image instruction from a second user. Logic 52 establishes that the first user has priority over the second user, and modifies image data 48 according to the first image instruction.

In the illustrated embodiment, logic 52 includes a processor 54, an I/O manager 58, a display adapter 62, an operating system 64, a display driver 68, a gesture recognition module 72, an input adapter 76, a mouse driver 80, and Universal Serial Bus (USB) drivers 84.

Input adapter 76 processes input to I/O server 30 and then sends the input to I/O manager 58. In one embodiment, input adapter 76 receives a sensor signal representing a user gesture and determines which user has sent the input. For example, a particular sensor may send signals representing user gestures from a particular user. In one embodiment, input adapter 76 may select the application 42 that receives the input. For example, input adapter 76 may use gesture recognition module 72 to select application 42.

Gesture recognition module 72 identifies the instruction that corresponds to a gesture. In one embodiment, gesture recognition module 72 receives a request from input adapter 76 to identify a gesture. Gesture recognition module 72 accesses a gesture profile 51 and determines a user instruction mapped to the gesture. Gesture recognition module 72 then sends the user instruction to input adapter 76.

Gesture recognition module 72 may create and manage gesture profiles 51. In one embodiment, gesture recognition module receives a request to update a gesture profile 51 for a user. Gesture recognition module 72 receives signals representing gestures from the user and instructions corresponding to the gestures. Gesture recognition module 72 maps the gestures to their corresponding instructions and stores the mappings a gesture profile 51.

I/O manager 58 manages the operation of I/O server 30, and tracks input to and/or output from I/O devices 40 and applications 42. In one embodiment, I/O manager 58 communicates with wrappers 46 to track the input to and/or output from applications 42. In the embodiment, I/O manager 58 gathers updates from wrappers 46 and manager 58 sends user input to wrappers 46.

In one embodiment, I/O manager 58 tracks and updates output for I/O devices 40, such as the images displayed on I/O devices 40. In the embodiment, I/O manager 58 receives an image request from display adapter 62 and replies with a most recent bit map for the requested image. When I/O manager 58 receives user input from input adapter 76, I/O manager 58 forwards the input to wrapper 46.

Display adapter 62 provides image data 48 that can be used to display an image at I/O devices 40. Display adapter 42 may also resolve image data 48 for display. In one embodiment, display adapter 62 receives image data 48 comprising a bitmap from I/O manager 58 and adjusts the bitmap for display. For example, display adapter 62 determines a user orientation of a user and adjust image data 48 in accordance with the user orientation. In the example, display adapter 52 determines that according to a first user orientation, a first edge of a monitor is the top and a second edge is the bottom. Display adapter 62 may adjust image data 48 such that the top of the image is at first edge and the bottom of the image is at the second edge. According to a second user orientation, the first edge may be the bottom and the second edge may be the top. Display adapter 62 may adjust image data 48 such that the top of the image is at second edge and the bottom of the image is at the first edge.

An input/output (I/O) device 40 represents a device configured to receive input and/or provide output. Examples of I/O devices 40 include computers, touch screens, personal digital assistants, and telephones. In the illustrated embodiment, I/O devices 40 (40a, 40b, 40c, and/or 40d) include a horizontal I/O surface device 40a, a vertical I/O surface device 40b, a mouse 40c, and a keyboard 40d.

An I/O device 40 may have an I/O surface. An I/O surface may be a surface that receives input and provides output. The input may be provided by touch, and the output may be an image. A touch screen is an example of an I/O surface. Horizontal I/O surface device 40a may have a substantially horizontal I/O surface, and may comprise a tabletop computer. Vertical I/O surface device 40b may have a substantially vertical I/O surface, and may comprise a wall display. An I/O device 40 may have one or more projectors 90 (90a and/or 90b) and one or more monitors 94 (94a and/or 94b). A projector 90 may comprise a DLP projector that projects image onto monitor 94.

An input/output device may generate an input signal in response to a user. For example, an I/O device 40 may generate a sensor signal in response to a user making contact with a sensor. In one embodiment, the sensor signal indicates a gesture performed by a user, such as the path of the user's touch along I/O surface. The path may be defined by a series of points from the beginning of the path to the end of the path and by the speed of travel along the path.

In the illustrated embodiment, horizontal I/O surface device 40a comprises a tabletop computer, where projector 90a and monitor 94a are disposed within a table with an I/O surface. In one embodiment, an array of antennas may be disposed within the I/O surface. Each antenna transmits a unique signal, and each user has a separate receiver that is connected to the user, such as through the user's chair. When a user touches the I/O surface, antennas near the touch point couple a small amount of signal through the user's body into the receiver. Accordingly, the user may input a gesture through the I/O surface.

I/O devices 40 may be at the same or different locations. For example, I/O devices 40 may be at different locations to allow users to collaborate remotely. Different users may use the same or different input devices. For example, a first user uses a first I/O surface and a second user uses a second I/O surface, or both users may use the same I/O surface.

A component of system 10 may include an interface, logic, memory, and/or other suitable element. An interface receives input, sends output, processes the input and/or output, and/or performs other suitable operation. An interface may comprise hardware and/or software.

Logic performs the operations of the component, for example, executes instructions to generate output from input. Logic may include hardware, software, and/or other logic. Logic may be encoded in one or more tangible media and may perform operations when executed by a computer. Certain logic, such as a processor, may manage the operation of a component. Examples of a processor include one or more computers, one or more microprocessors, one or more applications, and/or other logic.

A memory stores information. A memory may comprise one or more tangible, computer-readable, and/or computer-executable storage medium. Examples of memory include computer memory (for example, Random Access Memory (RAM) or Read Only Memory (ROM)), mass storage media (for example, a hard disk), removable storage media (for example, a Compact Disk (CD) or a Digital Video Disk (DVD)), database and/or network storage (for example, a server), and/or other computer-readable medium.

Modifications, additions, or omissions may be made to system 10 without departing from the scope of the invention. The components of system 10 may be integrated or separated. Moreover, the operations of system 10 may be performed by more, fewer, or other components. For example, the operations of display adapter 62 and input adapter 76 may be performed by one component, or the operations of I/O manager 58 may be performed by more than one component. Additionally, operations of system 10 may be performed using any suitable logic comprising software, hardware, and/or other logic. As used in this document, “each” refers to each member of a set or each member of a subset of a set.

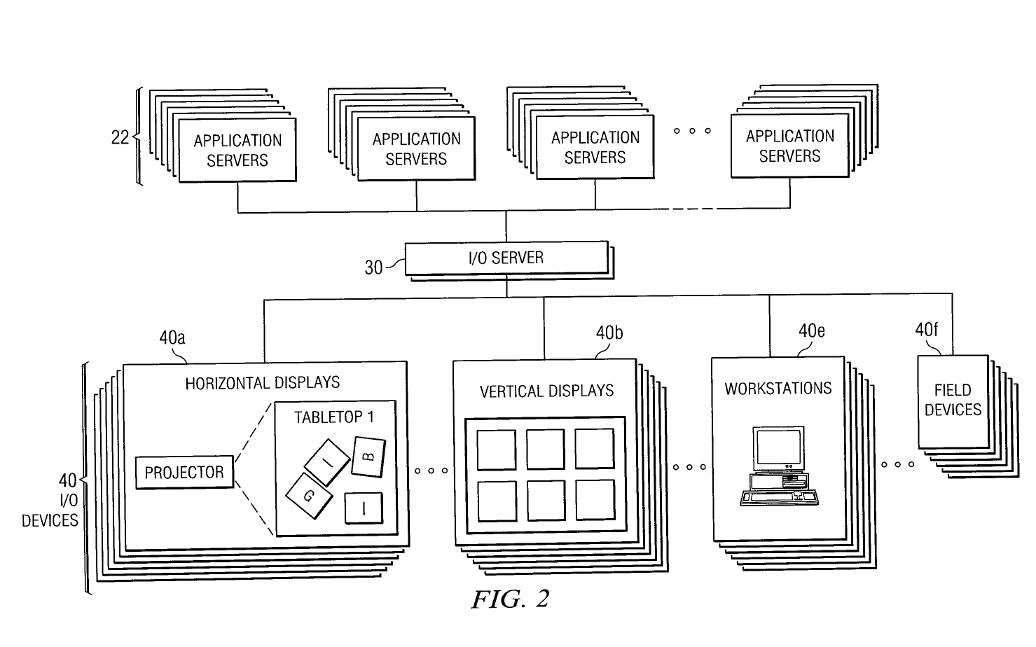

FIG. 2 illustrates another example of system 10 that has a collaboration net of servers. System 10 includes application servers 22, I/O server 30, and I/O devices 40 coupled as shown. Application servers 22 may form a collaboration net of servers. I/O devices 40 include horizontal I/O surface device 40a, vertical I/O surface device 40b, work stations, and field devices 40e such as tablets, personal digital assistants (PDAs), and telephones.

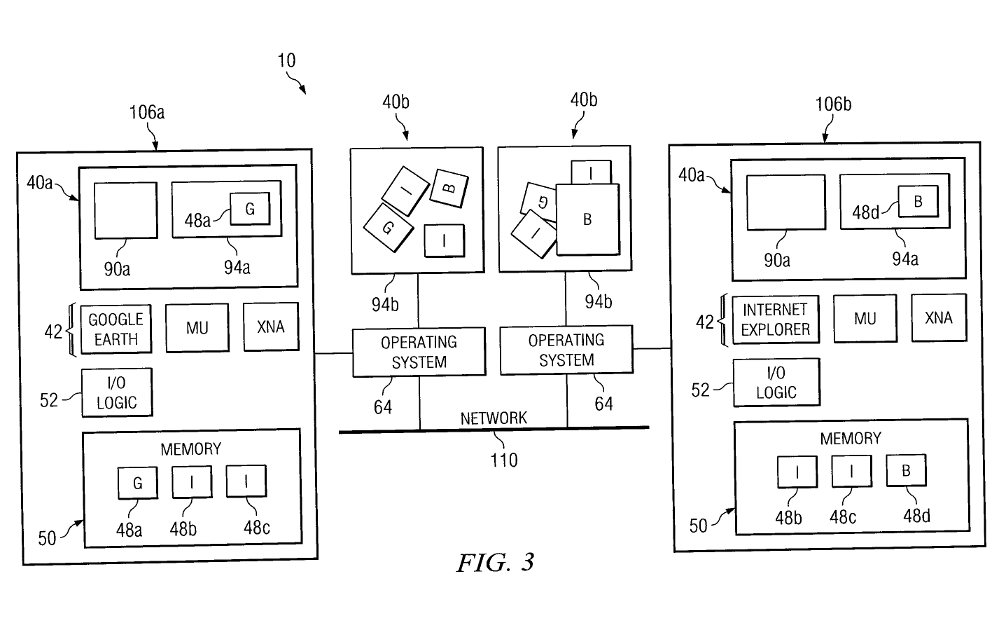

FIG. 3 illustrates another example of system 10 that includes stations. System 10 includes stations 106 (106a and/or 106b), I/O devices 40b, operating systems 64, and a network 110 coupled as shown.

Network 110 allows for communication between the components of system 10, and may comprise all or a portion of one or more of the following: a public switched telephone network (PSTN), a public or private data network, a local area network (LAN), a metropolitan area network (MAN), a wide area network (WAN), a local, regional, or global communication or computer network such as the Internet, a wireline or wireless network, an enterprise intranet, other suitable communication link, or any combination of any of the preceding.

Station 106 includes a horizontal I/O surface device 40a, applications 42, I/O logic 52, and memory 50. In the illustrated example, applications 42 of station 106a includes GOOGLE EARTH, Multiple User (MU), and MICROSOFT XNA applications, and applications 42 of station 106b includes INTERNET EXPLORER, MU, and MICROSOFT XNA applications. I/O logic 52 includes logic 52 of I/O server 30 described with reference to FIG. 1. Memory 50 of station 106a includes image data 48a, 48b, and 48c, and memory 50 of station 106b includes image data 48b, 48c, and 48d.

Horizontal surface I/O device 40a includes projector 90a and monitor 94a. In the illustrated embodiment, monitor 94a of station 106a displays image data 48a, and monitor 94a of station 106b displays image data 48d.

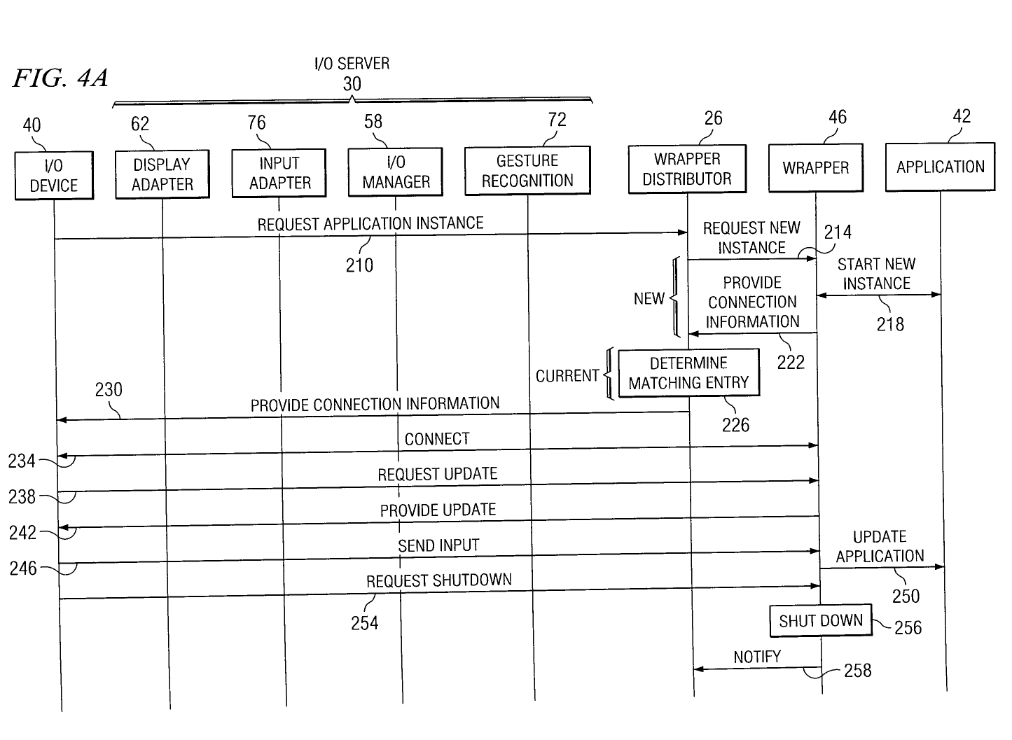

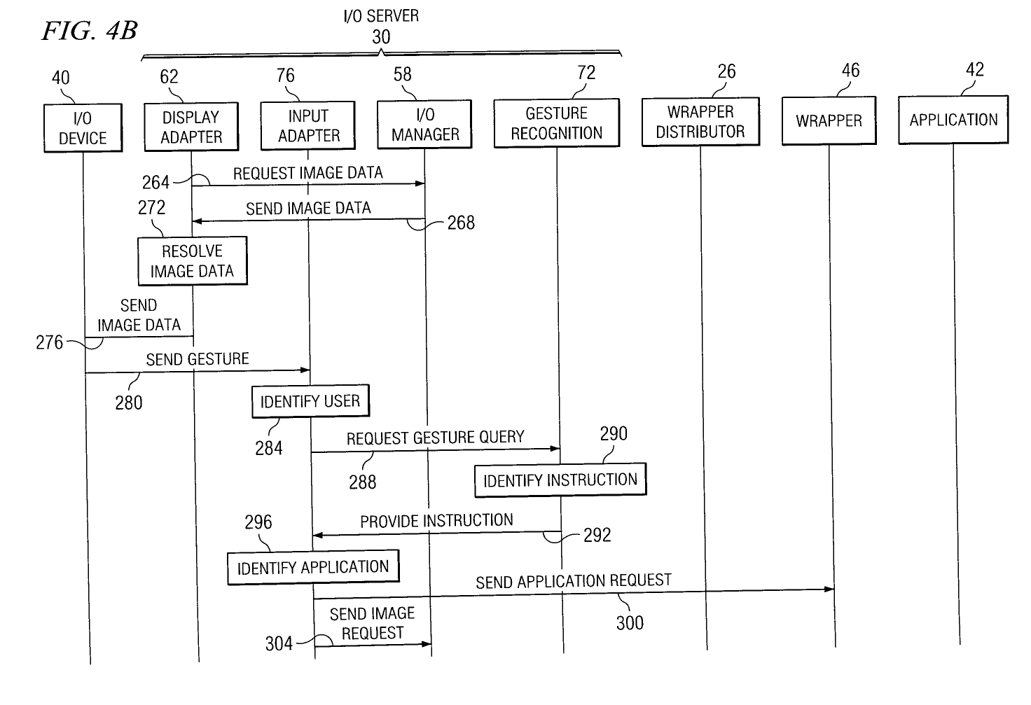

FIG. 4 illustrates an example of a method for facilitating access to application 42. The method starts at step 210, where I/O server 30 requests an instance of application 42 at step 210. The request specifies whether the request is for a new instance or a currently running instance.

Steps 214 through 222 describe responding to a request for a new instance. Wrapper distributor 26 checks existing wrappers 46 to determine if there is capacity. If there is, wrapper distributor 26 sends a request for a new instance at step 214. Wrapper 46 starts a new instance of application 42 at step 218. Wrapper 46 sends connection information to wrapper distributor 26 at step 222. Wrapper distributor 26 records the connection information for the instance in an applications catalog and assigns a catalog identifier to the instance.

Step 226 describes responding to a request for a currently existing instance of application 42. A request for a currently running instance includes a catalog identifier of the instance. Wrapper distributor 26 checks the applications catalog for the catalog identifier. If the applications catalog includes the catalog identifier, wrapper distributor 26 accesses the corresponding connection information. The connection information is forwarded to I/O server 30 at step 230.

Steps 234 to 258 describe responding to application requests made by I/O server 30. I/O server 30 connects to wrapper 46 at step 334. I/O server 30 sends an update application view request to wrapper 46 at step 238. In response, wrapper 46 sends an updated bitmap of the application to I/O server 30 at step 242. I/O server 30 sends a send application inputs request to wrapper 46 at step 246. In response, wrapper 46 updates the application with the received inputs at step 250. I/O server 30 sends a shutdown application request to wrapper 46 at step 254. In response, wrapper 46 shuts down the application 42 at step 256, and notifies wrapper distributor 26 that wrapper 46 is not being used at step 258.

Steps 264 to 276 describe providing updated image data. Display adapter 62 sends an image request to I/O manager 58 at step 264. I/O manager 58 sends an updated image to display adapter 62 at step 268. Display adapter 62 resolves the image at step 272. For example, display adapter 62 may adjust the image according to a user orientation. Display adapter 62 sends the image to I/O device 40 at step 276.

Steps 280 to 304 describe responding to user input. Input adapter 76 receives a sensor signal from an I/O device 40 at step 280. The sensor signal indicates a gesture performed by a user. Input adapter 76 identifies the user corresponding to the sensor signal at step 284. In one embodiment, a sensor signal from a particular sensor may be associated with a particular user.

Input adapter 76 queries gesture recognition module 72 to identify an instruction associated with the gesture at step 288. Gesture recognition module 72 identifies the instruction corresponding to the gesture at step 290 using a gesture profile 51 of the user. Gesture recognition module 72 sends the instruction to input adapter 76 at step 292.

The instruction may be an application request for an application 42 or may be an image instruction to change an image. If the instruction is an application request, input adapter 76 identifies application 42 at step 296 and sends the application request to wrapper 46 associated with identified application 42 at step 300. Wrapper 46 responds to the request. If the instruction requests movement of an image, input adapter 76 may send the request to I/O manager 58, which responds to the request.

Modifications, additions, or omissions may be made to the method without departing from the scope of the invention. The method may include more, fewer, or other steps. Additionally, steps may be performed in any suitable order.

Certain embodiments of the invention may provide one or more technical advantages. A technical advantage of one embodiment may be that different users may effectively access the same instance of an application. Another technical advantage of one embodiment may be that a user gesture may be used to provide an instruction for the application.

Although this disclosure has been described in terms of certain embodiments, alterations and permutations of the embodiments will be apparent to those skilled in the art. Accordingly, the above description of the embodiments does not constrain this disclosure. Other changes, substitutions, and alterations are possible without departing from the spirit and scope of this disclosure, as defined by the following claims.

What is claimed is:

1. An apparatus comprising:
a memory configured to store image data generated by an instance of an application; and
logic embodied in one or more tangible media configured to repeat the following for each user of a plurality of users:
receive a sensor signal representing a gesture performed by the each user, the gesture indicating a user instruction;
modify the image data according to the user instruction; and
send the image data to initiate a display of an image according to the user instruction.

2. The apparatus of claim 1, the logic further configured to:
access a gesture profile for the each user; and
identify the user instruction corresponding to the gesture using the gesture profile.

3. The apparatus of claim 1, the logic further configured to perform the following for a user of the plurality of users:
receive a new sensor signal representing a new gesture for the user;
determine a new user instruction indicated by the new gesture; and
record the new gesture mapped to the new instruction in a gesture profile.

4. The apparatus of claim 1, the logic further configured to modify the image data according to the user instruction by:
determining a user orientation of the each user; and
adjusting the image data in accordance with the user orientation.

5. The apparatus of claim 1, the logic further configured to:
receive updated application data generated by the instance of the application; and
generate updated image data corresponding to the updated data.

6. The apparatus of claim 1, the logic further configured to perform the following for a user of the plurality of users:
receive an application request sensor signal representing an application request gesture performed by the each user, the application request gesture indicating an application request; and
send the application request to the application.

7. The apparatus of claim 1, the logic further configured to:
determine that the gesture indicates an image instruction to modify the image data instead of an application request.

8. The apparatus of claim 1, the logic further configured to repeat the following for each user of the plurality of users by:
receiving a first sensor signal representing a first gesture performed by a first user, the first gesture indicating a first user instruction;
receiving a second sensor signal representing a second gesture performed by a second user, the second gesture indicating a second user instruction;
establishing that the first user has priority over the second user; and
modifying the image data according to the first user instruction.

9. The apparatus of claim 1, the sensor signal generated by an input/output (I/O) surface.

10. The apparatus of claim 1, wherein:
the sensor signal representing a first gesture performed by a first user is generated by a first input/output (I/O) surface; and
the sensor signal representing a second gesture performed by a second user is generated by a second I/O surface.

11. A method comprising:
storing image data in a memory, the image data generated by an instance of an application; and
repeating the following using logic embodied in one or more tangible media, the following repeated for each user of a plurality of users:
receiving a sensor signal representing a gesture performed by the each user, the gesture indicating a user instruction;
modifying the image data according to the user instruction; and
sending the image data to initiate a display of an image according to the user instruction.

12. The method of claim 11, further comprising:
accessing a gesture profile for the each user; and
identifying the user instruction corresponding to the gesture using the gesture profile.

13. The method of claim 11, further comprising performing the following for a user of the plurality of users:
receiving a new sensor signal representing a new gesture for the user;
determining a new user instruction indicated by the new gesture; and
recording the new gesture mapped to the new instruction in a gesture profile.

14. The method of claim 11, the modifying the image data according to the user instruction further comprising:
determining a user orientation of the each user; and
adjusting the image data in accordance with the user orientation.

15. The method of claim 11, further comprising:
receiving updated application data generated by the instance of the application; and
generating updated image data corresponding to the updated data.

16. The method of claim 11, further comprising performing the following for a user of the plurality of users:
receiving an application request sensor signal representing an application request gesture performed by the each user, the application request gesture indicating an application request; and
sending the application request to the application.

17. The method of claim 11, further comprising:
determining that the gesture indicates an image instruction to modify the image data instead of an application request.

18. The method of claim 11, the repeating the following for each user of the plurality of users further comprising:
receiving a first sensor signal representing a first gesture performed by a first user, the first gesture indicating a first user instruction;
receiving a second sensor signal representing a second gesture performed by a second user, the second gesture indicating a second user instruction;
establishing that the first user has priority over the second user; and
modifying the image data according to the first user instruction.

19. The method of claim 11, the sensor signal generated by an input/output (I/O) surface.

20. The method of claim 11, wherein:
the sensor signal representing a first gesture performed by a first user is generated by a first input/output (I/O) surface; and
the sensor signal representing a second gesture performed by a second user is generated by a second I/O surface.

21. An apparatus comprising:
a memory configured to store image data generated by an instance of an application; and
logic embodied in one or more tangible media configured to:
repeat the following for each user of a plurality of users:
receive a sensor signal representing a gesture performed by the each user, the gesture indicating a user instruction, the sensor signal generated by an input/output (I/O) surface;
access a gesture profile for the each user;
identify the user instruction corresponding to the gesture using the gesture profile;
modify the image data according to the user instruction by:
determining a user orientation of the each user; and
adjusting the image data in accordance with the user orientation; and
send the image data to initiate a display of an image according to the user instruction; and
perform the following for a user of the plurality of users:
receive a new sensor signal representing a new gesture for the user;
determine a new user instruction indicated by the new gesture; and
record the new gesture mapped to the new instruction in a gesture profile.
